(19) United States
(12) Patent Application Publication
(10) Pub. No.: US 2006/0023241 A1
(43) Pub. Date: Feb. 2, 2006

(54) Method of outputting image by automatic recognition of table image, terminal device and computer program product employing such a method

(75) Inventor: Raiko Funakami, Tokyo (JP)

Correspondence Address: MORRISON & FOERSTER LLP, 425 MARKET STREET, SAN FRANCISCO, CA, 94105-2482, US

(73) Assignee: ACCESS CO., LTD., Tokyo (JP)

(21) Appl. No.: 11/188,255

(22) Filed: Jul. 22, 2005

(30) Foreign Application Priority Data
Jul. 30, 2004 (JP) 2004-224121

(51) Int. Cl. G06F 3/12; G06F 15/00

(52) U.S. Cl. 358/1.13; 358/1.15

(57) ABSTRACT

A method of acquiring an image contained in a page described with a markup language and outputting the acquired image is provided. The method includes the steps of a judgment step of judging whether or not a table in a page contains an image laid out as a table, a selection step of allowing a user to select a whole image laid out as a table as one object of selection when the table is judged in the judgment step to contain such an image laid out as a table, and an image output step of outputting the image laid out as a table as one file in response to an instruction to save the image laid out as a table.

### INCORPORATION BY REFERENCE

This application claims priority of Japanese Patent Application No. 2004-224121, filed on Jul. 30, 2004, the entire subject matter and entire content of the applications being incorporated herein by reference.

### BACKGROUND OF THE INVENTION

The present invention relates to a technique for storing image data during browsing of content existing on a network.

A user of a browser referring to a page described with a markup language (e.g. a Web page) can sometimes hope to save an image currently displayed on a screen. To meet such a request, various browsers designed to be able to store a displayed image have been provided. A method for storing an image by use of such a browser has been described in Chapter 6-86 (pages 230-231) of “Quick Effect! Illustrated Windows XP, Comprehensive Edition (by Yoshikazu Akutsu and Yusaku Yasuda),” Mainichi Communications Inc. (2003).

According to the above document, the user can save an image contained in the currently displayed Web page as a local file by (1) moving the mouse cursor to the image on the Web page so that an image tool bar will be called up, (2) clicking and selecting a command “Save Image in Specified Folder” from the image tool bar so that a pop-up window (for letting the user designate the destination of the local file in a local memory, etc.) will be called up, and (3) designating the name of the local file to be saved, the destination of the local file, etc. in the pop-up window.

### SUMMARY OF THE INVENTION

By the image storing method using a browser described in the above document, the user can save an image on a Web page as a local file by operating the mouse of a PC. However, such an image storing method is not necessarily capable of meeting every request of the user hoping to save images while browsing pages. For example, images displayed on a Web page can include not only ordinary images but also an image laid out as a table (i.e. an image configured as a combination of a plurality of partial images by assigning image files to cells of the table respectively). In this specification, such an image laid out as a table will be referred to as a “table image”. Incidentally, each table on a page described with the markup language is specified by a <table> tag.

Since the aforementioned partial images (contained in a table image) often have a certain meaning as one image when they are laid out as a table, it is natural for many users of browsers to hope to save a table image (containing a plurality of partial images) as one image file. Therefore, the convenience for the users can be enhanced by providing the browser with a function of saving a table image (containing a plurality of partial images) as one image file. Such saving of a table image as one image file has not been taken into consideration or incorporated in image storing functions of browsers (like the one described in the above document).

The present invention which has been made in consideration of the above problems is advantageous in that an image output method, a terminal device and a program, capable of outputting a table image (an image laid out as a table) as one image file for the purpose of image saving, etc., can be provided.

According to an aspect of the invention, there is provided a method of acquiring an image contained in a page described with a markup language and outputting the acquired image. The method includes the steps of a judgment step of judging whether or not a table in a page contains an image laid out as a table, a selection step of allowing a user to select a whole image laid out as a table as one object of selection when the table is judged in the judgment step to contain such an image laid out as a table, and an image output step of outputting the image laid out as a table as one file in response to an instruction to save the image laid out as a table.

With this configuration, the user browsing a page is allowed to select a whole table image so that the selected table image (containing one or more partial images) will be outputted as one file, by which the convenience for the user is enhanced in regard to image storing during page browsing.

Optionally, the table may be judged to contain an image laid out as a table in the judgment step if at least one of cells of the table contains an image.

Still optionally, the selection step may include the step of putting a focus on the whole image laid out as a table on a display screen.

Still optionally, the image output step may include the step of extracting the image laid out as a table from the table as a rectangular area, and outputting the extracted image as one file.

In a particular case, part of the rectangular area corresponding to cells containing no image may be filled with a prescribed color in the extracting step.

Optionally, the image output step may include the step of forming the one file by obtaining data of images contained in the image laid out as a table from data of the page described with the markup language and combining the images according to layout of the table.

Still optionally, the image output step may include the steps of rendering data of the image laid out as a table based on data of the page described with the markup language, and outputting the image laid out as a table as the one file based on the data after the rendering.

Still optionally, the image output step may include the step of rendering the whole table and outputting the rendered table as the one file.

Still optionally, the image output step may include the step of storing the image laid out as a table as one local file.

Still optionally, a following process may be executed when the table is judged in the judgment step to contain an image laid out as a table:
(A1) recognizing one or more anchor tags contained in the table;
(A2) starting acquisition of objects of URIs of the recognized anchor tags; and
(A3) starting up a new window for a browsing process and displaying of the objects with the start of the acquisition of the objects.

According to another aspect of the invention, there is provided a computer program product comprising computer-readable instructions that cause a computer to execute an image output method for acquiring an image contained in a page described with a markup language and outputting the acquired image. The image output method includes a judgment step of judging whether or not a table in an obtained page contains an image laid out as a table, a selection step of allowing a user to select a whole image laid out as a table as one object of selection when the table is judged in the judgment step to contain such an image laid out as a table, and an image output step of outputting the image laid out as a table as one file in response to an instruction to save the image laid out as a table.

With this configuration, the user browsing a page is allowed to select a whole table image so that the selected table image (containing one or more partial images) will be outputted as one file, by which the convenience for the user is enhanced in regard to image storing during page browsing.

According to another aspect of the invention, there is provided a terminal device used for browsing a page described with a markup language. The terminal device is provided with a judgment unit which judges whether or not a table in an obtained page contains an image laid out as a table, a selection unit which allows a user to select a whole image laid out as a table as one object of selection when the table is judged by the judgment unit to contain such an image laid out as a table, and an image output unit which outputs the image laid out as a table as one file in response to an instruction to output the image laid out as a table.

With this configuration, the user browsing a page is allowed to select a whole table image so that the selected table image (containing one or more partial images) will be outputted as one file, by which the convenience for the user is enhanced in regard to image storing during page browsing.

Optionally, the image output unit may store the image laid out as a table as a local file.

### BRIEF DESCRIPTION OF THE ACCOMPANYING DRAWINGS

The objects and features of the present invention will become more apparent from the consideration of the following detailed description taken in conjunction with the accompanying drawings, in which:

FIG. 1 is a block diagram showing the composition of a terminal device in accordance with an embodiment of the present invention;

FIG. 2 is a functional block diagram of a browser as browsing software operating under the control of a CPU of the terminal device;

FIG. 3 is a state transition diagram of the browser shown in FIG. 2;

FIG. 4 is a flow chart showing the procedure of an image storing process executed by the browser of FIG. 2;

FIG. 5 is a schematic diagram showing an example of a table as the target of the image storing process of FIG. 4;

FIG. 6 is a schematic diagram showing a state in which a table image has been extracted as a rectangular area by applying the image storing process of FIG. 4 to the table of FIG. 5;

FIG. 7 is a flow chart showing another example of a procedure of the image storing process;

FIG. 8 is a schematic diagram explaining tree structure of a Web page;

FIG. 9 is a schematic diagram showing an example of a table image obtained by applying the image storing process of FIG. 7 to the table of FIG. 5;

FIG. 10 is a schematic diagram showing another example of a table image obtained by applying the image storing process of FIG. 7 to the table of FIG. 5;

FIG. 11 is a schematic diagram showing an example of a table containing a table image including a plurality of anchor tags;

FIG. 12 is a schematic diagram showing another example of a table as the target of the image storing process; and

FIG. 13 is a schematic diagram showing a state in which a table image has been extracted as a rectangular area by applying the image storing process of FIG. 4 to the table of FIG. 12.

### DETAILED DESCRIPTION OF THE EMBODIMENTS

Hereinafter, an embodiment according to the invention is described with reference to the accompanying drawings.

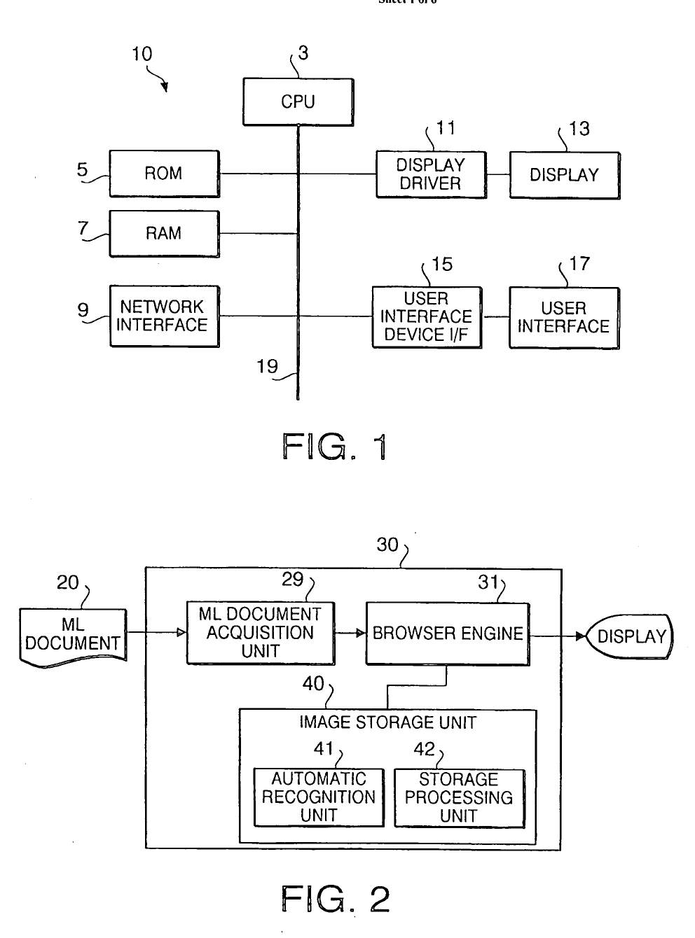

FIG. 1 is a block diagram showing a configuration of a terminal device 10 in accordance with an embodiment of the present invention. FIG. 2 is a functional block diagram of a browser 30, as browsing software operating under the control of a CPU 3 of the terminal device 10. In this embodiment, the terminal device 10 is assumed to be a device having a smaller display screen than a PC (Personal Computer), such as a cellular phone.

As shown in FIG. 1, the terminal device 10 includes the CPU 3 for the overall control of the device, a ROM 5 storing various programs for letting the terminal device 10 perform prescribed operations, a RAM 7, a network interface 9, a display driver 11 and a user interface device I/F 15. The above components are connected together by a bus 19. To the CPU 3, a display 13 and a user interface device 17 are connected via the display driver 11 and the user interface device I/F 15, respectively.

The user interface device 17 is a key operation unit including a cross-shaped key (four-way arrow key), numeric keys, a confirmation key, etc. A program of the browser 30 which will be explained later is stored in the ROM 5, and the browser 30 starts up in response to a prescribed operation by the user to the user interface device 17.

FIG. 2 is a functional block diagram showing functions of the browser 30. When the user inputs a URI (Uniform Resource Identifier) or selects an anchor (URI) on a Web page currently displayed, an ML (Markup Language) document 20 of the URI designated by the user is obtained by an ML document acquisition unit 29 via a network and inputted to a browser engine 31. The browser engine 31 has functions of interpreting, rendering and displaying the ML document 20.

Specifically, the browser engine 31 includes a parser, a page maker and a formatter as its functional blocks. The parser interprets a logical structure of the ML document 20 and thereby generates a document tree regarding the structure of the ML document. Incidentally, the document tree does not contain information on expressions of the document. The page maker generates a layout tree containing information on various expressive forms (block, inline, table, list, item, etc.) specified by tags, based on the document tree. The layout tree indicates the order of arrangement of the elements (block, inline, table, etc.) of the ML document. However, the layout tree does not contain information on the layout of the elements, such as the position and the size (width, height) of each element displayed on the screen, where to start new lines (positions of line feeds in character strings), etc.

The formatter sets the layout based on the layout tree, using information on the actual display screen (e.g. display screen width). In other words, the formatter determines the positions of line feeds and the position, width and height of each element on the actual display screen while successively arranging the contents of the layout tree on the screen. By the above process executed by the browser engine 31 including the parser, the page maker and the formatter, the ML document 20 is displayed on the display screen of the terminal device 10.

The browser 30 further includes an image storage unit 40 which operates to store one or more images existing in a Web page. By the function of the image storage unit 40, the user can save desired images currently displayed on the Web page in a local memory such as a flash memory (unshown in FIG. 1). The image storage unit 40 has a function of storing a table image (an image laid out as a table) as one image file.

The image storage unit 40 includes an automatic recognition unit 41 and an image storage processing unit 42. The automatic recognition unit 41 automatically recognizes whether each table has been configured as a table image or not. The image storage processing unit 42 stores the table image according to a prescribed format when a preset operation is performed by the user. Examples of criteria for the recognition of the table image by the automatic recognition unit 41 will be described below.

<Criteria of Judgment>

For example, the automatic recognition unit 41 may recognize a table as a table image when at least one image file (specified by an “img” tag) is contained in the cells of the table.

The above criterion is effective as the condition of judgment since the criterion (condition) covers the majority of cases where a table has been configured as a table image and the criterion simplifies the automatic recognition process. The automatic recognition unit 41 can obtain information necessary for its operation from the browser engine 31. The above criterion of judgment is only an example and the automatic recognition unit 41 may also employ other criteria for the recognition of a table image. The following are examples of other criteria.
(1) A table contains two or more image cells and the image cells are adjoining.
(2) Numbers included in the names of images in a table are consecutive (e.g. a case where the names of image files are “hp0.gif”, “hp1.gif”, “hp2.gif” and “hp3.gif”).
(3) A table contains at least one image and the image has a link.

The automatic recognition unit 41 may also employ a combination of two or more of the above examples as the criterion of judgment.

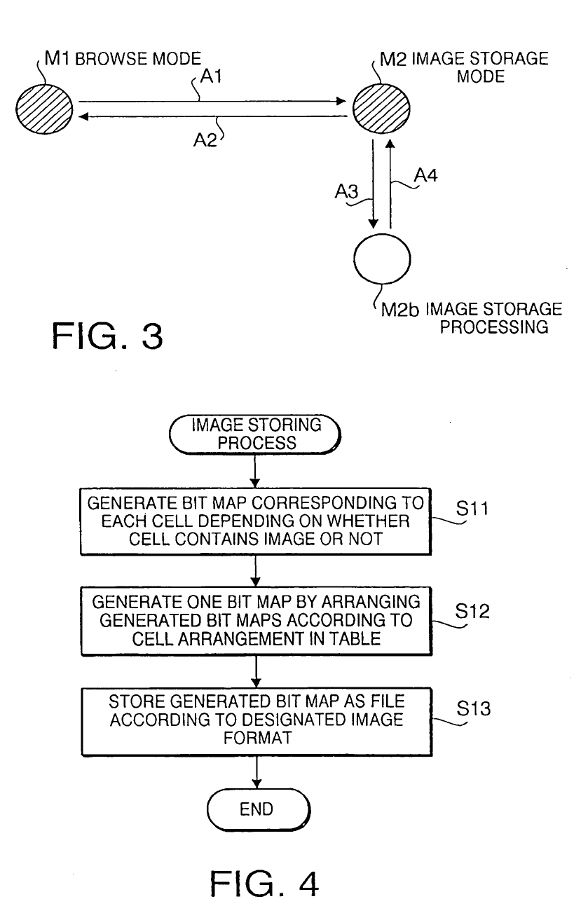

FIG. 3 is a state transition diagram of the browser 30. The browser 30 has two operation modes: a browse mode M1 for letting the user perform the browsing operation and an image storage mode M2 in which images can be saved. In the image storage mode M2, by the function of the image storage unit 40, the user can perform an operation for saving a table image as one file. The image storage mode M2 may be configured to allow the user also to save ordinary images other than table images.

State transitions between the above two modes are caused by operations by the user with the user interface device 17. From the browse mode M1, the state shifts to the image storage mode M2 when the user selects the image storage mode from a menu or by pressing shortcut keys, for example (arrow A1). In the image storage mode M2, the user can select an image (i.e. put the focus on the image) by operating the cross-shaped key. From the image storage mode M2, the state shifts to the browse mode M1 when the user presses a “Back” key (assigned to one of the keys of the user interface device 17), for example (arrow A2).

In the image storage mode M2, the automatic recognition unit 41 functions so as to recognize whether each table is a table image or not, by which the user is allowed to select the whole table image as one image (i.e. put the focus on the whole table image). An image storing process M2b for storing the selected table image is executed when the user presses a “Save” key (assigned to one of the keys of the user interface device 17) while putting the focus on the table image, for example (arrow A3). The image storing process is executed by the image storage processing unit 42. After the image storing process is finished, the browser 30 automatically returns to the previous state (image storage mode M2) allowing image selection (arrow A4).

FIG. 4 is a flow chart showing the procedure of the image storing process M2b shown in FIG. 3. Incidentally, information on images necessary for the image storing process can be obtained from the browser engine 31. The image storing process of FIG. 4 is started when image storing is designated in a state in which a table image (containing one or more partial images) has already been selected by the user in the image storage mode M2. First, in step S11, a bit map corresponding to each cell of the table is generated depending on whether the cell contains an image or not. In this step, the bit map for each cell is generated as below.
(a1) When the cell contains an image, a bit map of the image is generated. Width/height attributes of the cell are obtained when they have been specified, and the bit map is generated according to the width/height attributes.
(a2) When the cell contains no image, a bit map for filling the cell with a prescribed color (e.g. white) is generated. The width/height attributes of the cell are obtained when they have been specified and the bit map is generated according to the width/height attributes.

In a next step S12, a bit map is generated by arranging the bit maps generated in the step S11 according to the cell arrangement in the table. In a next step S13, the generated bit map is stored as a local file according to a proper image format (an image format designated by the user, for example). By the above process, a table image (containing one or more partial images) selected by the user is saved as one file.

Incidentally, while a bit map of each cell is generated and thereafter the bit maps of the cells are stored as a file in the above process, the generation of the bit maps is not necessarily essential. For example, it is also possible to directly store the images of the cells as a file, taking the cell arrangement in the table in consideration.

Further, when a table includes a cell containing no image (e.g. a blank cell, a cell containing text only, etc.), the above image storing process may further include a step of extracting a table image as a rectangular area while excluding blank/text cells.

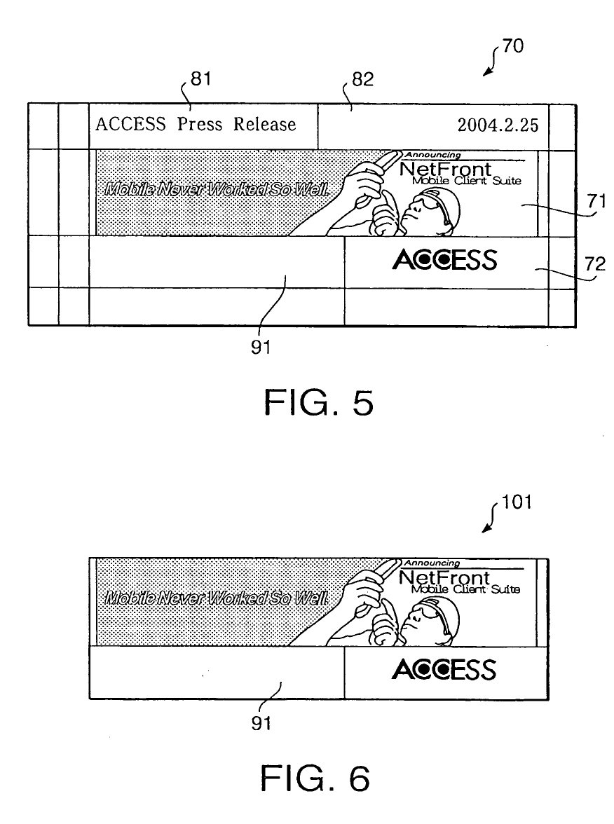

An example of a case where a table image is stored by the image storing process of FIG. 4 will be explained below. FIG. 5 is a schematic diagram showing a table 70 as an example of a table as a target of the image storing process. The table 70 includes image cells 71 and 72, text cells 81 and 82, and a plurality of blank cells.

FIG. 6 is a schematic diagram showing a state in which a table image 101 has been extracted as a rectangular area by applying the image storing process of FIG. 4 to the table 70. The rectangular table image 101 is formed by filling a part corresponding to a blank cell 91 with a prescribed color (e.g. white). The table image 101 is stored as one file.

FIG. 12 is a schematic diagram showing a table 200 as another example of a table as the target of the image storing process. The table 200 shown in FIG. 12 is composed of six cells 201-206, in which the cells 201, 202, 203 and 205 are image cells, the cell 204 is a blank cell, and the cell 206 is a text cell. In the table 200, the combination of the cells 201, 202, 203 and 205 forms an image having a certain meaning. By the aforementioned criteria of judgment, the table 200 is judged to contain a table image.

FIG. 13 is a schematic diagram showing a state in which a table image 210 has been extracted as a rectangular area by applying the image storing process of FIG. 4 to the table 200. In the table image 210, a part 214 corresponding to the blank cell 204 has been filled with white, and a part 216 corresponding to the text cell 206 has also been filled with white. The table image 210 is stored as one file.

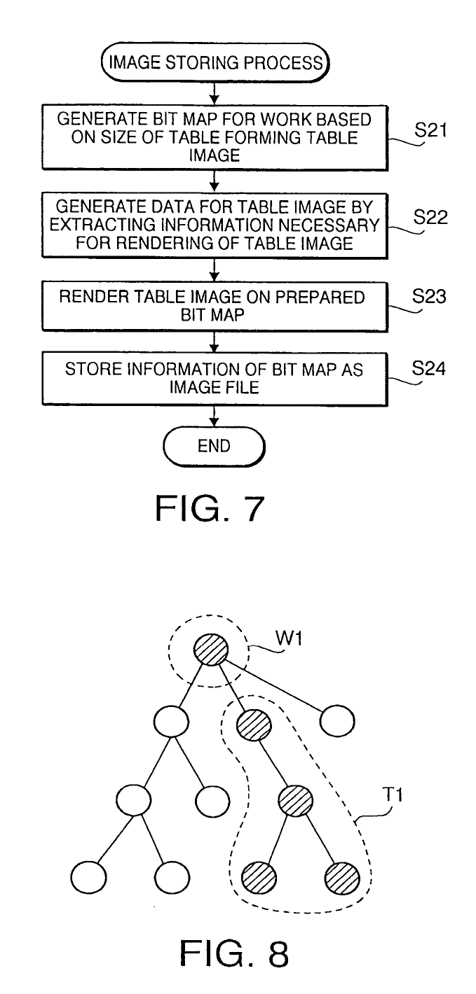

FIG. 7 is a flow chart showing another example of a procedure of the image storing process. In the above procedure of FIG. 4, an image is formed by extracting images from the table and combining the images according to the cell arrangement of the table. In the following procedure of FIG. 7, a part that is recognized as a table image is processed by rendering and thereafter saved as a file.

First, in step S21, a bit map for work is generated based on the size of a table forming a table image. In this step, the width/height attributes specified for the whole table may be used, for example. In a next step S22, data for the table image is generated by extracting information necessary for the rendering of the table image from data that have been obtained by the browser engine 31. In a next step S23, the table image is rendered on the bit map prepared in the step S21. The bit map after the rendering is stored as a file (S24).

By the above process, a table image is saved as one file. By the image storing process of FIG. 7, a table image incorporating a background color of a text or blank cell, etc. can be generated. For example, when information for the rendering of a Web page containing a table image has a tree structure shown in FIG. 8 and information on the table image is a part T1 (surrounded by a broken line) in FIG. 8, the rendering is carried out using information W1 on a parent when a background color has to be incorporated in the blank cells.

Incidentally, the image storing process of FIG. 7 may be configured to extract a rectangular table image by excluding blank cells.

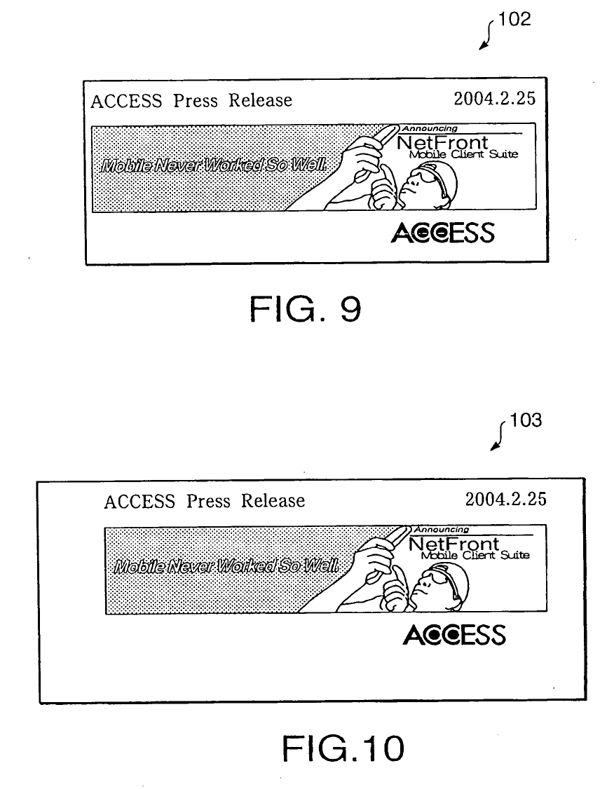

FIG. 9 is a schematic diagram showing an example of a table image obtained by applying the image storing process of FIG. 7 to the table 70 of FIG. 5. The table image 102 shown in FIG. 9 corresponds to the rendering of the cells 81, 82, 71, 72 and 91 of the table 70 shown in FIG. 5. In other words, the table image 102 of FIG. 9 shows an example of the case where a rectangular table image is extracted by excluding blank cells. The table image 102 has been formed as a rectangular image containing text cells. To a part of the table image 102 corresponding to the blank cell 91 of the table 70, designation of a background color, etc. is applied.

FIG. 10 is a schematic diagram showing another example of a table image obtained by applying the image storing process of FIG. 7 to the table 70 of FIG. 5. FIG. 10 shows an example of the case where the table image is generated by executing the rendering without excluding blank cells. The table image 103 shown in FIG. 10 contains all the cells of the table 70. To parts of the table image 103 corresponding to the blank cells of the table 70, designation of a background color, etc. is applied.

The browser 30 may also be provided with an additional function of executing a process for obtaining the objects of URIs specified by anchor tags in a table simultaneously in the case where the table is recognized to be formed as a table image. Specifically, the process for the additional function may be implemented by a procedure described below. Incidentally, the browser 30 is assumed here to have a “tab browser function” of displaying a plurality of pages in one window (hereinafter referred to as a “tab window”) by switching the pages using tabs, for example.
(C1) First, whether the table includes a table image or not is recognized. This step can be implemented by the function of the automatic recognition unit 41.
(C2) Anchor tags in the table are recognized.
(C3) The acquisition of the objects of the URIs of the recognized anchors is started.
(C4) With the start of the acquisition of the objects, a new tab window (or an ordinary window) is started up and the browsing process is carried out on the window.

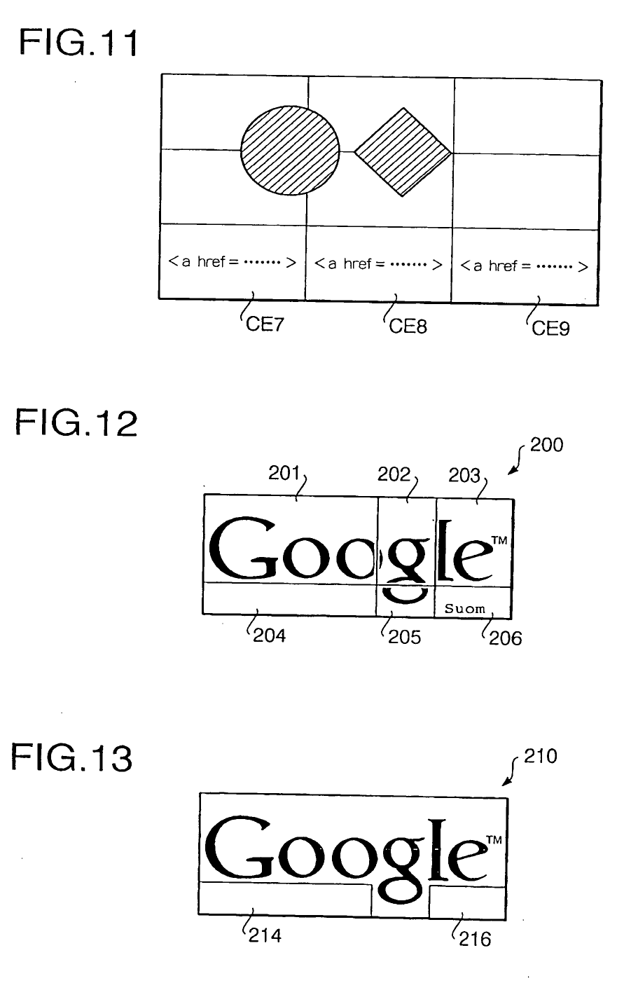

For example, when a table in a page contains nine cells (containing a table image) as shown in FIG. 11 and three of the cells (CE7, CE8 and CE9) contain anchor tags specifying HTML documents, the above process (C1)-(C4) is executed as follows. When the table of FIG. 11 is recognized to include a table image, the acquisition of the HTML documents specified by the anchor tags in the cells CE7, CE8 and CE9 is started, and at the same time, a new tab window for page browsing is displayed. While the user is browsing the table of FIG. 11, the HTML documents specified by the three cells are acquired simultaneously, by which the user can open and browse desired HTML documents in the tab window.

In the above process, the acquisition of the documents specified by the anchor tags (URIs) may either be started automatically or in response to an instruction by the user. By the above process, a plurality of HTML documents specified by the anchors in the table (i.e. the objects) are acquired simultaneously, by which the convenience for the user is increased.

As described above, by the terminal device 10 in accordance with the embodiment of the present invention, the user browsing a page can select the whole table image and save the selected table image as one file, by which the convenience for the user is enhanced in regard to image storing during page browsing.

While a description has been given above of a preferred embodiment in accordance with the present invention, the present invention is not to be restricted by the particular illustrative embodiment and a variety of modifications, design changes, etc. are possible without departing from the scope and spirit of the present invention. For example, while the terminal device 10 in the above embodiment has been assumed to be a cellular phone, the present invention can be implemented in various types of devices such as a personal computer. Also in such cases, the convenience for the user regarding image storing during browsing of information can be enhanced similarly to the above embodiment.

While the image storage unit 40 in the above embodiment operates to output (store) a table image (generated as one image file) as a local file in the terminal device 10, the table image generated as one file may be outputted in various ways (printing, outputting as a mail attachment file, etc) to be utilized by the user.

The device and method according to the present invention can be realized when appropriate programs are provided and executed by a computer. Such programs may be stored in recording medium such as a flexible disk, CD-ROM, memory cards and the like and distributed. Alternatively or optionally, such programs can be distributed through networks such as the Internet.

What is claimed is:

1. A method of acquiring an image contained in a page described with a markup language and outputting the acquired image, comprising:
a judgment step of judging whether or not a table in a page contains an image laid out as a table;
a selection step of allowing a user to select a whole image laid out as a table as one object of selection when the table is judged in the judgment step to contain such an image laid out as a table; and
an image output step of outputting the image laid out as a table as one file in response to an instruction to save the image laid out as a table.

2. The image output method according to claim 1, wherein the table is judged to contain an image laid out as a table in the judgment step if at least one of cells of the table contains an image.

3. The image output method according to claim 1, wherein the selection step includes the step of putting a focus on the whole image laid out as a table on a display screen.

4. The image output method according to claim 1, wherein the image output step includes the steps of:
extracting the image laid out as a table from the table as a rectangular area; and
outputting the extracted image as one file.

5. The image output method according to claim 4, wherein part of the rectangular area corresponding to cells containing no image is filled with a prescribed color in the extracting step.

6. The image output method according to claim 1, wherein the image output step includes the step of forming the one file by obtaining data of images contained in the image laid out as a table from data of the page described with the markup language and combining the images according to layout of the table.

7. The image output method according to claim 1, wherein the image output step includes the steps of:
rendering data of the image laid out as a table based on data of the page described with the markup language; and
outputting the image laid out as a table as the one file based on the data after the rendering.

8. The image output method according to claim 1, wherein the image output step includes the step of rendering the whole table and outputting the rendered table as the one file.

9. The image output method according to claim 1, wherein the image output step includes the step of storing the image laid out as a table as one local file.

10. The image output method according to claim 1, wherein a following process is executed when the table is judged in the judgment step to contain an image laid out as a table:
(A1) recognizing one or more anchor tags contained in the table;
(A2) starting acquisition of objects of URIs of the recognized anchor tags; and
(A3) starting up a new window for a browsing process and displaying of the objects with the start of the acquisition of the objects.

11. A computer program product comprising computer-readable instructions that cause a computer to execute a method of acquiring an image contained in a page described with a markup language and outputting the acquired image, the method comprising:
a judgment step of judging whether or not a table in an obtained page contains an image laid out as a table;
a selection step of allowing a user to select a whole image laid out as a table as one object of selection when the table is judged in the judgment step to contain such an image laid out as a table; and
an image output step of outputting the image laid out as a table as one file in response to an instruction to save the image laid out as a table.

12. A terminal device used for browsing a page described with a markup language, comprising:
a judgment unit which judges whether or not a table in an obtained page contains an image laid out as a table;
a selection unit which allows a user to select a whole image laid out as a table as one object of selection when the table is judged by the judgment unit to contain such an image laid out as a table; and
an image output unit which outputs the image laid out as a table as one file in response to an instruction to output the image laid out as a table.

13. The terminal device according to claim 12, wherein the image output unit stores the image laid out as a table as a local file.
